(19) United States
(12) Patent Application Publication
(10) Pub. No.: US 2026/0279218 A1
(43) Pub. Date: Sep. 17, 2026

(54) GRADING USER RESPONSE SYSTEM FOR A TURNING A PARAGRAPH INTO SINGLE PARAGRAPH OUTLINE EDUCATIONAL ACTIVITY USING INTEGRATED PROGRAMMATIC LOGIC AND SPECIALIZED GUIDED AND CONSTRAINED ARTIFICIAL INTELLIGENCE

(71) Applicant: 2hr Learning, Inc., Austin, TX (US)

(72) Inventors: Joshua Singer, Claymont, DE (US); Cameron Kelley, Austin, TX (US); Alex Stanciu, Penn Valley, PA (US)

(73) Assignee: 2hr Learning, Inc., Austin, TX (US)

(21) Appl. No.: 19/566,952

(22) Filed: Mar. 13, 2026

Related U.S. Application Data
(60) Provisional application No. 63/771,508, filed on Mar. 13, 2025.

(51) Int. Cl. G09B 7/04; G06F 40/30; G06F 40/40

(52) U.S. Cl. CPC G09B 7/04; G06F 40/30; G06F 40/40

(57) ABSTRACT

A system and method guides an Artificial Intelligence (AI) engine to grade a user response submitted for turn-paragraph into single paragraph educational outline activity is disclosed. A grading input including a presented question along with user response is received by turn-paragraph into single paragraph educational outline activity grader. The presented question includes a paragraph and one or more placeholders where user adds his response during the activity. A set of prompts are generated via a prompt generator and transferred to the AI engine for evaluating the user response based on one or more pre-defined criteria. Post evaluation, a grading output is generated as Boolean response ‘pass’ if the user response passes each of the pre-defined criteria and ‘fail’ if the user response fails on at least one pre-defined criteria. The grading output is presented to the user along with a feedback via a user interface.

### CROSS-REFERENCE TO RELATED APPLICATION(S)

This application claims the benefit under 35 U.S.C. § 119(e) and 37 C.F.R. § 1.78 of U.S. Provisional Application No. 63/771,508, which is incorporated by reference in its entirety.

### FIELD OF THE INVENTION

The present invention relates in general to the field of electronics, and more specifically to artificial intelligence guided system and method for grading content related to ‘turn paragraph into single paragraph educational outline activity.

### DESCRIPTION OF THE RELATED ART

Grading is foundational in education, acting as a key method for evaluating learner's understanding and progress in a particular subject. In traditional educational system, grading is carried out by teachers, professors, or other academic professionals responsible for evaluating learner's work. These assessments typically include assignments, tests, quizzes, and projects. The educators use specific guidelines to determine how well a learner has met learning objectives. These guidelines may include correctness, completeness, analytical depth, creativity, clarity of expression, and adherence to instructions.

Grading in traditional educational system is conducted manually, requiring educators to review each learner's submission carefully and assign scores or marks based on established standards. The grading process does not provide feedback to learners about their performance. The grading process can be subjective, as it depends on human interpretation and judgment. The educators may consider multiple factors when assigning grades. In some cases, grading can be influenced by biases, inconsistencies, or variations in assessment criteria

To make the grading process faster and more scalable, a rule-based method is used. Rule-based methods automate keyword-based checking and accelerates the evaluation process. However, this method has limitations. Such evaluation methods only check keyword responses as per the rules and does not evaluate other important language features like grammar or style. Changing the rules for different questions and exercises is generally a cumbersome process. Additionally, such grading processes fail to provide personalized feedback or guidance to the learners.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary activity generation and grading system.

FIG. 2 depicts an exemplary AI-guided turn-paragraph into single paragraph outline (SOP) educational activity grading system for evaluating and grading user response to a turn-paragraph into single paragraph outline educational activity.

FIG. 3 depicts an exemplary AI-guided turn paragraph into single paragraph educational outline activity grading process for evaluating and grading the user response to the turn paragraph into single paragraph outline educational activity.

FIG. 4 depicts an exemplary flowchart showing the functions performed by the AI-guided ‘turn paragraph into single paragraph educational outline activity grading system of FIG. 2.

FIG. 5 depicts an exemplary diagram showing data structures used to structure and organize the data of the AI-guided ‘turn paragraph into single paragraph educational outline activity grading system of FIG. 2.

FIG. 6 depicts an exemplary ecosystem diagram including system components used by the AI-guided turn-paragraph into single paragraph educational outline activity grading system of FIG. 2.

FIG. 7 is an exemplary user interface depicting various elements of an online learning platform.

FIGS. 8-9 are exemplary user interfaces depicting example where a user is practicing the ‘turn paragraph into single paragraph educational outline activity.

FIGS. 10-13 are exemplary user interfaces depicting the correction process for updating at least one topic sentence based on feedback.

FIGS. 14-16 are exemplary user interfaces depicting the correction process for updating one or more supporting sentences based on feedback.

FIGS. 17-19 are exemplary user interfaces depicting the correction process for updating a concluding sentence based on feedback.

FIG. 20 depicts an exemplary network environment in which the AI-guided turn-paragraph into single paragraph educational outline activity grading system of FIG. 2 and the AI-guided turn-paragraph into single paragraph educational outline activity grading process of FIG. 3 may be practiced.

FIG. 21 depicts an exemplary computer system.

### DETAILED DESCRIPTION

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than both any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

A programmatic AI engine management system generates decomposed, technically engineered AI prompts to include selected and integral AI engine guidance and constraints. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics. For example, in an educational context, the grading of questions, attempted by a user to practice turn-paragraph into single paragraph educational outline activity, on criteria such as semantic analysis of topic sentence, concluding sentences, and supporting sentences provided by the user.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to grade questions attempted by user on predefined evaluation criteria that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

The present disclosure relates to a system and method for guiding an Artificial Intelligence (AI) engine for grading a user response submitted for turn-paragraph into single paragraph educational outline activity. The process begins by receiving a grading input including a presented question including a paragraph along with a plurality of placeholders where the user adds the response and the user response. A set of prompts are generated via a prompt generator are transferred to the AI engine for evaluating the user response based on one or more pre-defined criteria.

The one or more pre-defined criteria include checking if the at least one topic sentence matches the actual topic sentence of the paragraph, verifying if the concluding sentence matches the concluding sentence of the paragraph, checking if each supporting sentence is relevant and paraphrased. Moreover, generating a grading output for the user response such that the grading output is ‘pass’ if the user response passes against each of the pre-defined criteria, and the grading output is ‘fail’ if the user response fails on at least one of the pre-defined criteria. Furthermore, presenting the grading output along with feedback to the user on an online learning platform.

Moreover, the one or more placeholders allow the user to provide one or more sentences include at least one topic sentence, one or more supporting sentences, and a concluding sentence to restate the information within the provided paragraph. Additionally, the number of supporting sentences required depends on the difficulty level: for difficulty level ‘easy’ the number of supporting sentences required from the user is 1, for difficulty level ‘medium’ supporting sentences required from the user is 2, and for difficulty level hard supporting sentences required from the user is 3. The user interface of the online learning platform present a hint to the user if the grading output is ‘fail’, the hint guides the user towards re-write at least one of: topic sentence, supporting sentence, concluding sentence without disclosing the answer.

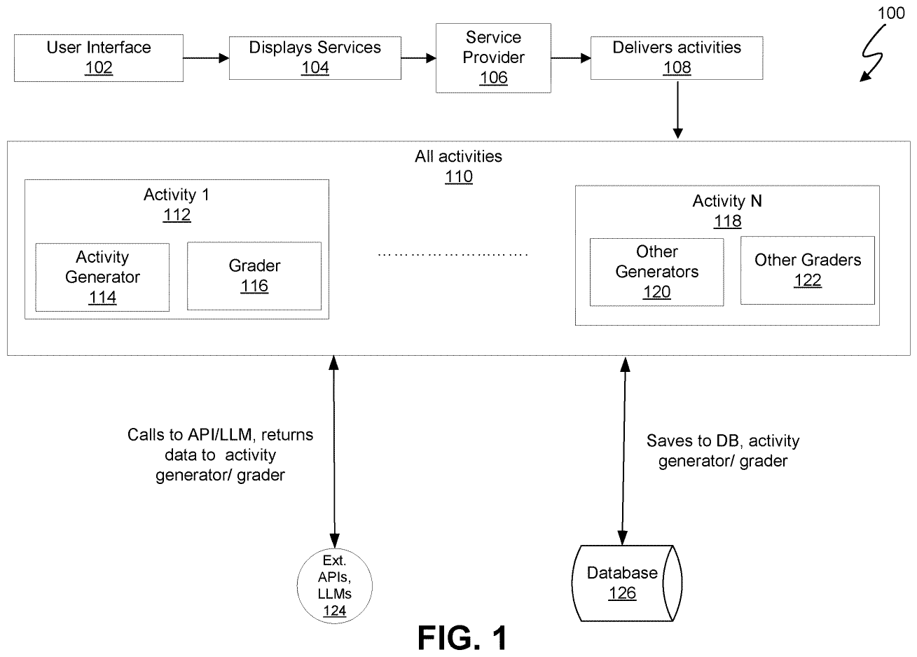

FIG. 1 depicts an exemplary activity generation and grading system 100.

The activity generation and grading system 100 is an AI-powered educational platform designed to automate the generation and grading of a plurality of language-based exercises. The AI-powered educational platform, which is an online learning platform (not shown in the figure) is designed to enhance reading comprehension skills for K-12 students. A user interface 102, integrated within the online learning platform, provides multiple educational services 104 on behalf of a service provider 106. The service provider 106 includes a plurality of services in the form of educational platforms. The user can select the service of his/her choice from the user interface 102. The user interface 102 presents a variety of activities 108, such as reading comprehension question generation, appositive exercises, sentence completion tasks, subordinating conjunction exercises, topic sentence generation, and so on. All activities 110 are dynamically created by their corresponding activity generator and assessed by a grader, ensuring an enhanced learning experience for users. As shown, variety of activities 108 includes ‘Activity 1’ 112 generated by an activity generator 114 and n other activities denoted as ‘Activity n’ 118, which are generated by other generators 120. The ‘Activity 1’ 112 in the present disclosure is ‘turn paragraph into SPO question’ activity, where a paragraph is displayed to the user and the user writes an outline of the paragraph.

The activity generator 114 and the corresponding activity generators orchestrate the entire process of activity generation. The activity generator 114 and the corresponding activity generators generate the variety of activities 110, evaluate workflows, import necessary modules, and populate prompts with appropriate variables to generate various exercises, such as reading comprehension questions, sentence completion tasks, and grammar exercises. For instance, the activity generator 114 generates a turn paragraph into Single Paragraph Outline (SPO) question. For this purpose, the activity generator 114 fetches input data using one or more external APIs (Application Programming Interface) 124 and LLM (Large Language Models). The input data may include grade level, and topics. The input data may vary based on the type of activity generated by the corresponding activity generator. The activity generator 114 ensures that the turn paragraph into SPO question is set aligned with the grade level and topic. The activity generator 114 generates learning activities dynamically.

Once the activity is generated, a grader 116 takes over the evaluation process for the activity generated by the activity generator 114. Similarly, activities generated by the other generators 120 will be evaluated by respective graders 122. The grader 116 assesses user's response to determine correctness using methods such as semantic similarity analysis and pre-defined criteria. The grader 116 not only provides a binary correct/incorrect evaluation but also offers detailed explanations for incorrect answers. These explanations include textual evidence, structured reasoning, and adaptive hints to help learners understand their mistakes. The grader 116 can also dynamically adjust question difficulty based on the user's past performance, ensuring a gradual and adaptive learning experience.

The grader 116 evaluates the user response by checking correctness. The grader 116 may use techniques such as semantic similarity analysis to determine whether the text fully supports the answer. If the generated activity is incorrect, the grader 116 provides structured explanations, including textual evidence and reasoning, to help the learner understand their mistake. This feedback mechanism enhances the learning experience, ensuring adaptive difficulty adjustments and preventing question redundancy. This is for the case of the activity generated by the activity generator 114. However, when other activity generators generate the corresponding activity like topic sentence generation, appositive generation, and so on, the corresponding grader evaluates the response provided by the user may provide a response to the user in binary format (Yes/No), an explanation when the answer provided by the user is incorrect, a hint to the user in case of the incorrect answer, and so on.

One or more external APIs 124 or LLMs exchange the fetched data between different components, specifically the activity generator 114 and the grader 116. The one or more APIs or LLMs 124 act as communication bridges, ensuring seamless data exchange between the user interface 102, the activity generator 114, and the grader 116. When the user interacts with the user interface 102, such as selecting the turn paragraph into SPO question activity, the one or more external APIs 124 retrieves the relevant grade level and topics. This information is then sent to the activity generator 114, which processes the data, generates a suitable question, and formats it for presentation to the user.

Once the user submits the response, the one or more external APIs 124 exchanges this response, along with the corresponding question, to the grader 116 for evaluation. The grader 116 assesses the correctness of the answer, often using techniques like semantic similarity analysis and key sentence extraction. If the response is incorrect, the grader generates an explanation, referencing textual evidence to clarify why the selected choice is wrong and what the correct answer should be. The final feedback is then sent back to the user interface through the one or more external APIs 124, ensuring a smooth and efficient learning experience. Finally, the generated activity along with the response is stored in a database 126. For instance, in the case of the present example, the generated reading comprehension question and single-choice answer set along with the explanation are stored in the database 126 and presented to the user via the user interface 102.

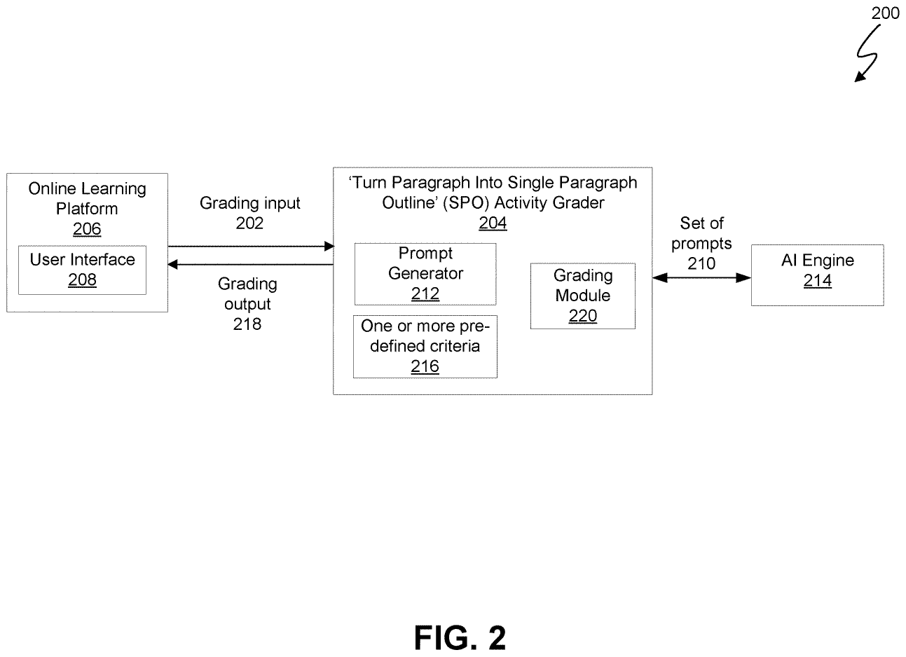

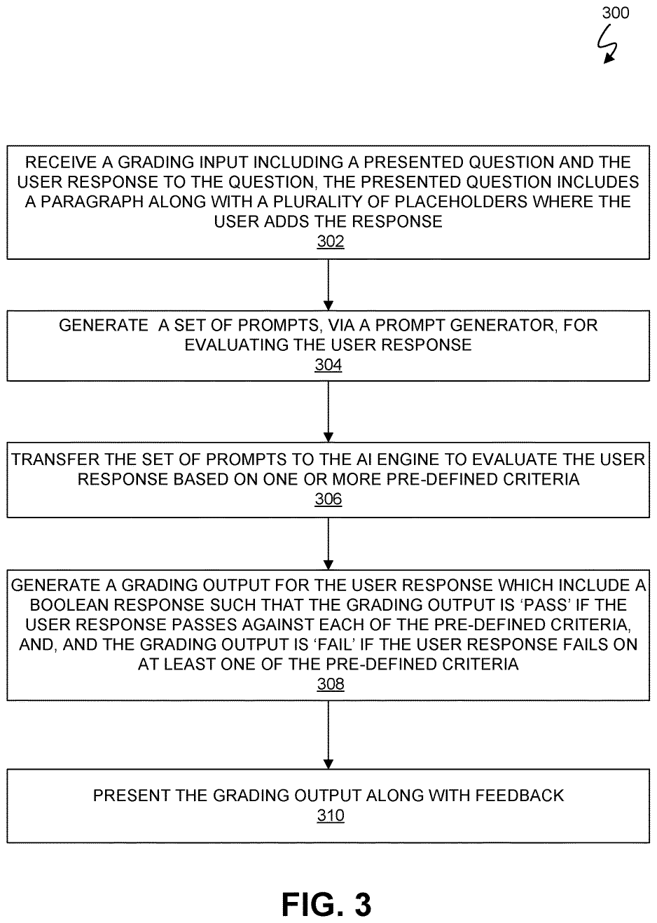

FIG. 2 depicts an exemplary AI-guided ‘turn paragraph into single paragraph educational outline activity grading system 200 configured to evaluate and grade user response to a ‘turn paragraph into single paragraph outline educational activity. FIG. 3 depicts an exemplary AI-guided ‘turn paragraph into single paragraph educational outline activity grading process 300 utilized by the ‘turn paragraph into single paragraph educational outline activity grading system 200 of FIG. 2.

Referring to FIGS. 2 and 3, in operation 302, a ‘turn paragraph into single paragraph educational outline activity grader 204 receives a grading input 202 including a presented question and the user response to the question. The presented question includes a paragraph along with a plurality of placeholders where the user adds the response. The user response includes at least one topic sentence, one or more supporting sentences, and a concluding sentence.

The grading input 202 includes answer submitted by the user to the question presented to the user while practicing a ‘turn paragraph into SPO’ activity on an online learning platform. The grading input 202 serves as input data that include the displayed question and the corresponding user response for the displayed question that allows the ‘turn paragraph into SPO’ activity grader 204 to assess the understanding and skills of the user in relation to the content of the ‘turn paragraph into SPO’ activity. For example, the grading input 202 may include user typed one or more sentences in response to the question displayed via the user interface 208 of the online learning platform 206, which is then evaluated by the ‘turn paragraph into SPO’ activity grader 204.

The ‘turn paragraph into SPO’ activity is a specific type of learning exercise that asks the user to create one or more structured sentences from a paragraph displayed via the user interface 208. The user is supposed to provide at least one topic sentence, one or more supporting sentences, and a concluding sentence in his response. The ‘turn paragraph into SPO’ activity tests user's ability to synthesize information, organize thoughts, and present ideas in a clear and concise manner.

The presented question is the specific query that is given to the user as part of the activity. The presented question sets the stage for what the user is expected to respond to. In ‘turn paragraph into SPO’ activity, the presented question typically includes a paragraph having textual information, which may come from a variety of sources such as databases, articles, or other learning materials. The paragraph explains a concept, and the user is supposed to fill information based on the paragraph in the plurality of placeholders. The plurality of placeholders guides the user on where to insert response, ensuring that the user focusses on the key elements required in the task. For instance, the presented question might present a paragraph about environmental sustainability and include placeholders where the user is expected to user response.

An example of a presented question could be:
“Converting a short paragraph about “Recycling Paper” into an SPO.”
“Recycling paper reduces waste in landfills. It also conserves natural resources. Therefore, everyone should recycle paper whenever possible.”

The user response is the answer provided by the user to the presented question. The user response must address the plurality of placeholders. The user response includes at least one topic sentence, one or more supporting sentences, and a concluding sentence.

The at least one topic sentence is a structured response, introduces the main idea or central theme of the paragraph. In the ‘turn paragraph into SPO’ activity, the at least one topic sentence typically aligns with the overall question. For example, if the presented question is about ‘Recycling Paper’, the at least one topic sentence introduce the specific aspect of recycling paper, such as waste reduction. The at least one topic sentence acts as a guiding statement, setting the context for the rest of the paragraph. An example of the at least topic sentence for the ‘Recycling Paper’ could be: ‘Recycling paper reduces waste in landfills.’

The one or more supporting sentences provide details, evidence, or reasoning that backs up the main idea presented in the at least one topic sentence. The one or more supporting sentences elaborate on the topic and make the discussion robust. In the case of the ‘Recycling Paper’ example, the one or more supporting sentences elaborate on how reducing waste helps protect ecosystems, conserve resources, and minimize pollution. For example: ‘It helps protect forests and cut down on trash’, ‘Reusing paper is good for the environment.’

The concluding sentence serves to summarize or restate the main point of the paragraph in a concise manner. The concluding sentence wraps up the discussion and reinforces the point of view. In example about ‘Recycling Paper’, the concluding sentence can be: ‘Therefore, everyone should recycle paper whenever possible’

Once the user submits the response, the grading input 202 is processed by the ‘turn paragraph into SPO’ activity grader 204. The ‘turn paragraph into SPO’ activity grader 204 evaluates the response based on a set of prompts 210.

In operation 304, a prompt generator 212 generates the set of prompts 210 for evaluating the user response.

The set of prompts 210 refer to instructions designed to evaluate the user response. The set of prompts 210 guide the AI engine 214 to assess and evaluate the user response. The dynamic nature of the set of prompts 210 ensures that the text within the set of prompts 210 include the plurality of placeholders for gathering user response, the question with one or more placeholders and additional specifications. The additional specifications include background information and context relevant to the evaluation task, along with detailed instructions on how to implement the evaluation process.

The set of prompts 210 serve as a guiding element that directs the AI engine 214 to grade the user response. The set of prompts 210 involve formulating a set of instructions, parameters, and contextual elements that are utilized to grade the user response including at least one topic sentence, one or more supporting sentences and concluding sentence. The set of prompts 210 is designed to ensure that the AI engine 214 evaluates the user response to ensure alignment with the educational standards. Exemplary educational standard used to evaluate user response may be include Common Core English Language Arts.

The prompt generator 212 is a tool that constructs the set of prompts 210 that guides the AI engine 214 to grade the user response. The prompt generator 212 analyzes the grading input 202 to create the set of prompts 210. The generated set of prompts 210 is provided to the AI engine 214 to grade the user response. In at least one embodiment, the set of prompts 210 is generated by the prompt engineer. In at least another embodiment, the skeleton of the set of prompts 210 is prepared by the prompt engineer and then the skeleton is provided to the prompt generator 212 to generate a final set of prompts 210.

In operation 306, the AI engine 214 receives the set of prompts 210 to evaluate the user response based on one or more pre-defined criteria

The AI engine 214 is integrated into the online learning platform 206 to handle various tasks, including grading, content creation, and personalized learning. The AI engine 214 is designed to simulate human cognition by understanding language, context, and meaning, which allows it to evaluate the user responses. The AI engine 214 uses natural language processing (NLP), and machine learning techniques to analyze the user response and determine how well it matches with the one or more pre-defined criteria. The AI engine 214 can automatically evaluate how well the user response aligns with the one or more pre-defined criteria by utilizing the set by the prompts 210, making the grading process objective, consistent, and scalable.

The set of prompts 210 may be manually entered by instructors into a database, where the AI engine 214 can retrieve the prompts for analysis. In another instance, the set of prompts 210 may be directly embedded into the ‘turn paragraph into SPO’ activity grading system 200, with the AI engine 214 receiving a real-time set of instructions when the user submits the response. The AI engine 214 begins evaluating the user response based on one or more pre-defined criteria 216. The one or more pre-defined criteria 216 are designed to measure the user ability to understand, organize, and respond to the question presented on the user interface 208. The one or more pre-defined criteria 216 for evaluation are typically predefined ensuring that the user response is evaluated consistently.

One of the first criteria in evaluating the user response is to check if the at least one topic sentence provided by the user matches the actual topic sentence of the paragraph. The topic sentence introduces the main idea or point that the paragraph will discuss, providing a clear direction for the rest of the content. In the evaluation process, the AI engine 214 analyzes whether the user has correctly identified the central theme of the paragraph and whether the at least one topic sentence accurately reflects the theme.

To evaluate the at least one topic sentence, the AI engine 214 compares the user provided topic sentence with the original topic sentence of the paragraph. The AI engine 214 uses natural language processing techniques to recognize synonyms, sentence structures, and context, determining if the user sentence conveys the same idea or not. If the topic sentence deviates too far from the original meaning or fails to align with the main idea of the paragraph, the engine flags the response for correction or gives a lower score.

Below is a prompt from the set of prompts 210 to evaluate the at least one topic sentence:
You are an English teacher grading a student exercise. The student was given this paragraph:
“$ {paragraph}”
The student was asked to identify the topic sentence. They wrote:
“$ {topicSentence}”
Did the student correctly identify the topic sentence? Answer with a Yes or No only.

The above prompt seeks a binary output verifying if the user identified topic sentence matches the actual topic sentence of the paragraph. The AI engine 214 is instructed to respond succinctly with “Yes” or “No.”

Another pre-defined criteria 216 include verifying if the concluding sentence provided by the user matches the concluding sentence of the paragraph. The concluding sentence of a paragraph provides closure and reinforcing the main point. The AI engine 214 evaluates whether the concluding sentence provided by the user matches the original concluding sentence of the paragraph. This criterion tests the ability of the user to summarize or conclude a discussion effectively.

To that end, the AI engine 214 compares the concluding sentence provided by the user with the original one, checking for semantic accuracy, meaning, and alignment with the overall purpose of the paragraph. The AI engine 214 also considers the context of the paragraph and the logical flow of the content to ensure that the conclusion of the user effectively wraps up the argument or discussion.

Below is a prompt from the set of prompts 210 to evaluate the concluding sentence:
You are an English teacher grading a student exercise. The student was given this paragraph:
“$ {paragraph}”
The student was asked to identify which sentence from the paragraph is the concluding sentence. The student answered with:
“$ {concludingSentence}”
Is the student's answer the *full*, not partial, complete concluding sentence? Do not consider partial answers correct. The student's answer should match the paragraph's concluding sentence in full. Answer with a Yes or No only.

The above prompt focuses on confirming whether the concluding sentence of the user is exactly the concluding sentence in the original text. Moreover, the partial matches are not acceptable, instructing the AI engine 214 to maintain a strict “Yes” or “No” output format.

Yet another r pre-defined criteria 216 include checking if each supporting sentence provided by the user is relevant to the paragraph. In addition to evaluating the at least one topic sentence and concluding sentences, the AI engine 214 also checks whether the one or more supporting sentences provided by the user are relevant to the paragraph. The one more supporting sentence is the foundation of the paragraph, as they provide evidence, explanations, or details that reinforce the main idea introduced in the at least one topic sentence. The relevance of the one or more supporting sentence enable to assess the user understanding.

The AI engine 214 scans the user response for the one or more supporting sentence and compares the supporting sentences to the original paragraph. The AI engine 214 analyzes whether the supporting sentences align with the core message and contribute meaningfully to the discussion. The evaluation involves complex analysis, as the AI engine 214 also determine if the supporting sentences are both conceptually and contextually relevant to the paragraph.

Below is a prompt from the set of prompts 210 to evaluate the one or more supporting sentence:
You are an English teacher grading a student exercise. The student was given this paragraph:
“$ {paragraph}”
The student was asked to identify supporting details in order to generate a Single Paragraph Outline. Here are the supporting details the student wrote:
   $ {note}
Do the student's supporting detail fit? Respond with Yes or No only

The above prompt checks if the user provided one or more supporting sentences are relevant to the paragraph. The AI engine 214 must again respond with a binary “Yes” or “No” evaluation response.

Another pre-defined criteria 216 include determining if the supporting sentence is a paraphrase rather than a direct copy from the paragraph. The AI engine 214 evaluates whether the one or more supporting sentence provided by the user are paraphrases rather than direct copies from the paragraph. Typically, paraphrasing is an important skill useful in both academic and professional contexts, as the skill demonstrates the ability of the user to rephrase ideas in one's own words while retaining the original meaning. This criterion helps evaluating if the user is able to demonstrate understanding of the paragraph rather than merely copying content from the paragraph.

The AI engine 214 uses an algorithm comparing user's response with the original paragraph to detect whether the one or more supporting sentence has been paraphrased effectively. The algorithm looks for similarities in structure, wording, and meaning, while checking for instances of plagiarism or direct copying. If the one or more supporting sentence closely mirrors the text from the paragraph without any rewording or original input, the AI engine 214 flags the response as potentially plagiarized.

Below is a prompt from the set of prompts 210 to evaluate the one or more supporting sentence for paraphrasing:

You are an English teacher grading a student exercise. The student was given this paragraph:
“$ {paragraph}”
The student was asked to identify supporting details in order to generate a Single Paragraph Outline. Here are the supporting details the student wrote:
   $ {note}
We don't want the student to exactly copy and paste the sentence. So notes should be relevant and similar to the detail sentences, but not verbatim copies. The detail sentence should have at least three words changed.
Does the student's supporting detail seem like a copy and paste, more or less? Respond with Yes or No only.
   The above prompt ensures the detail provided in supporting sentences is not verbatim from the paragraph, imposing a minimal threshold of originality. The AI engine 214 replies “Yes” if the sentences are copy-pasted, “No” if the sentences are paraphrased.

In operation 308, a grading output 218 is generated for the user response via a grading module 220. The grading output 218 includes a Boolean response such that the grading output 218 is ‘pass’ if the user response passes against each of the one or more pre-defined criteria, and the grading output 218 is ‘fail’ if the user response fails on at least one of the pre-defined criteria 216.

The grading module 220 determines whether the user response meets the expected standards, which are based on one or more pre-defined criteria 216. When creating the grading output 218, the AI engine 214 evaluates the user response against the one or more pre-defined criteria 216 and generates the Boolean outcome as ‘pass’ or ‘fail.’ The grading output 218 serves as a measure of success or failure, depending on how well the user response aligns with the pre-defined criteria 216.

The grading module 220 is responsible for generating the grading output 218, which functions as a decision-making component. The grading module 220 analyzes user response, compares the response to the one or more pre-defined criteria 216, and determines whether the user response meets the expected standards. If the user response fulfills all the criteria, the grading output 218 is ‘pass.’ However, if the response fails to meet even a single criterion, the grading output 218 is ‘fail,’ signaling to the user that further work or improvement is needed.

The grading module 220 relies on the one or more pre-defined criteria 216 to assess the quality of the user response. The one or more pre-defined criteria 216 are established based on the objectives of the learning activity and the desired learning outcomes. The one or more pre-defined criteria 216 are designed to assess specific components of the response, such as the clarity of the at least one topic sentence, the relevance of the one or more supporting sentences, and the accuracy of the concluding sentence.

When evaluating the at least one topic sentence, the grading module 220 check whether the user response includes a statement that aligns with the overall subject of the paragraph. When checking the appropriateness of the one or more supporting sentence, the grading module 220 evaluates whether the one or more supporting sentence in the user's response are both relevant and well-structured. The one or more supporting sentence that fail to provide useful information or stray from the topic of the paragraph may result triggering a flag. When validating the concluding sentence, the grading module 220 checks whether the user has effectively concluded the response by paraphrasing or summarizing the central argument, ensuring that the response maintains coherence and unity.

The grading output 218 is presented as the Boolean result ‘pass’ or ‘fail.’ Such a binary approach to grading is often preferred for simplicity and clarity. The ‘pass’ outcome indicates that the user response has successfully met all one more pre-defined criteria 216. In other words, the at least one topic sentence is aligned with the central theme, the one or more supporting sentences are relevant and clear, the concluding sentence is appropriate, and the user has demonstrated the ability to paraphrase effectively. The grading module 220 issues a ‘pass’ if every element of the response is consistent with the one or pre-defined criteria 216. For example, if the presented question is about the benefits of exercise, the grading module 220 might issue a ‘pass’ if the student:
a) Provides a clear topic sentence summarizing the importance of exercise.
b) Includes supporting sentences that offer relevant details, such as the physical and mental health benefits of exercise.
c) Include concluding statement that reinforces the idea of exercise being essential for health.
d) The user has demonstrated understanding of the paragraph without copying content directly from the paragraph.

On the other hand, a ‘fail’ outcome means that the user response has failed to meet one or more of the pre-defined criteria 216. If the user response is missing at least one topic sentence, contains irrelevant one or more supporting sentences, or includes the concluding sentence that introduces new information. In such instance, the grading module 220 will issue ‘fail.’ Additionally, if the user has copied content directly from the paragraph without demonstrating an understanding of the material, the AI engine 214 will flag this as a failure. Additionally, the grading module 220 is designed to be rigorous and precise in its evaluation, ensuring that the user receives constructive feedback that highlights areas for improvement.

In operation 310, the grading output 218 is presented along with a feedback via the user interface 208 on the online learning platform 206. The feedback includes detailed explanation about the grading output 218.

When the grading output 218 such as a ‘pass’ or ‘fail’, is generated, the result is displayed to the user, via the user interface 208, accompanied with by detailed and actionable feedback. The feedback helps the user to understand his/her performance, identify areas for improvement, and receive guidance on how to improve future submissions. The feedback helps the user to understand how well he/she performed on a particular assignment and highlights areas where the user fell short. The feedback is essential and helps the user understand why the user received the ‘pass’ or ‘fail’ as result. Also, the feedback shown along with the result provides the user with actionable steps to improve performance on the ongoing and future activities. Without the feedback, the users may feel confused or discouraged, particularly if the user do not understand what went wrong or how to improve performance in next activities. Therefore, presenting the grading output 218 alongside feedback helps the user to take ownership of their learning and progress journey.

The feedback can be personalized to address the specific strengths and weaknesses of individual users. The grading output 218 should be immediately visible upon submission to the user response, allowing users to quickly understand how the user performed. Typically, this is done through a clear display of the grading output 218, such as a ‘pass’ or ‘fail’ notice. In addition to the grading output 218, the feedback should be displayed in a way that is easy to read and comprehend. To that end, the feedback may be provided in a format using clear headings, bullet points, or sections.

In at least one embodiment, the user response is stored in the database. The storing the user response in the database include converting the user response into a JSON-formatted structure. The stored user response can be further utilized for generating personalized feedback for the user.

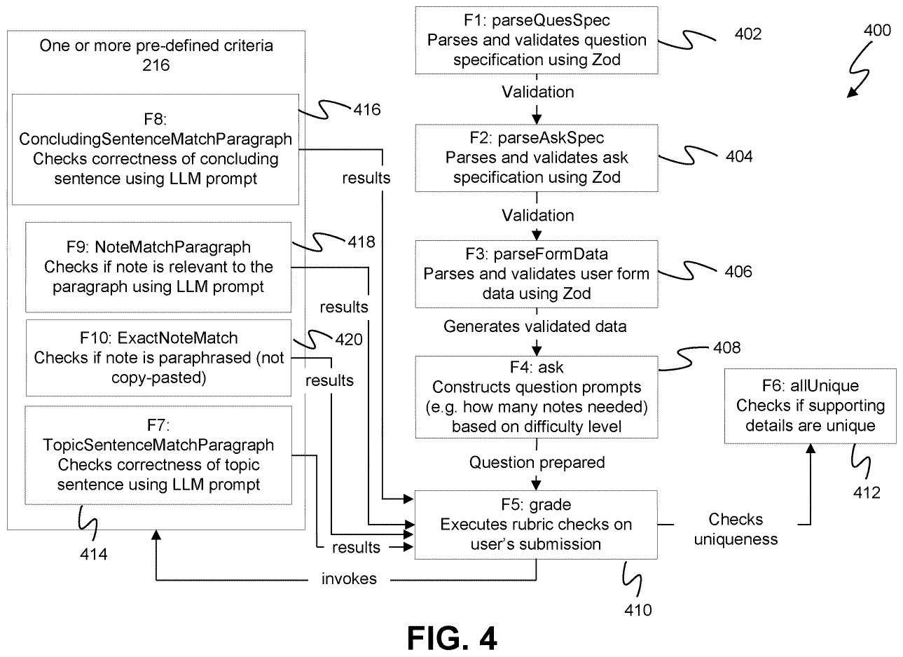

FIG. 4 depicts an exemplary flowchart 400 showing the functions performed by the AI-guided turn-paragraph into single paragraph educational outline activity grading system 200 of FIG. 2.

A function F1: parseQuestionSpec 402 validates and parses the raw question specification JSON into a typed object and provides to a function F2: parseAskSpec 404. The input given to the function F1: parseQuestionSpec 402 is unstructured JSON from the database or an external source. The output received is typed object representing the question specification. Moreover, the function F1: parseQuestionSpec 402 uses Zod for schema validation to ensure required fields are present. Zod is a TypeScript-first schema validation library that ensures data adheres to predefined rules, helping catch errors and enforce type safety. By utilizing Zod, the AI-guided turn-paragraph into SPO′ activity grading system 200 can verify that user response matches expected constraints reducing the risk of invalid or malicious data being processed.

The function F2: parseAskSpec 404 validates and parses the “ask” specification that indicates how many supporting sentences are expected. The input given to the function F2: parseAskSpec 404 is unstructured JSON referencing how many supporting sentences the student should provide. The output received from the function F2: parseAskSpec 404 is a typed object containing the number of supporting sentences for each paragraph. The function F2: parseAskSpec 404 also uses Zod to ensure schema integrity.

A function F3: parseFormData 406 validates and parses the student's form data submission. The input given to the function F3: parseFormData 406 is student's identified topic sentence, concluding sentence, and supporting sentences. The output received from the function F3: parseFormData 406 is a typed object with the user response. The exemplary code using function F1: parseQuestionSpec 402, function F2: parseAskSpec 404, and function F3: parseFormData 406 is shown below.

```
  public parseQuestionSpec (spec: Prisma.JsonValue):
TurnParagraph IntoSpoQuestionSpec {
    return TurnParagraphIntoSpoQuestionSpec. parse (spec);
  }
  public parseAskSpec (spec: Prisma. JsonValue):
TurnParagraph IntoSpoAskSpec {
    return TurnParagraphIntoSpoAskSpec. parse (spec);
  }
  public parseFormData (data: any): TurnParagraph IntoSpoFormData {
    return TurnParagraphIntoSpoFormData.parse (data);
  }
```

The given TypeScript code defines three functions: F1: parseQuestionSpec 402, F2: parseAskSpec 404, and F3: parseFormData 406 parsing input data using specific schema classes. Each function takes data, which is expected to be a JSON value (Prisma. JsonValue for the first two function and any for the third). The functions then pass the input to corresponding static parse functions

(TurnParagraphIntoSpoQuestionSpec.parse, TurnParagraph IntoSpoAskSpec.parse, and TurnParagraphIntoSpoFormData.parse), which likely validate and transform the input into typed objects. Therefore, ensuring that the input conforms to the expected structure before further processing.

A function F4: ask 408 prepares question to be displayed on the user interface 208 and also setting the count of supporting sentences based on difficulty level. The input provided to the function F4: ask 408 is the validated question specification and the difficulty level. The output received from the function F4: ask 408 is the data specifying how many supporting sentences the user must provide. The exemplary code for the function F4: ask 408 is shown below:

```
  public async ask (question: Question):
Promise<TurnParagraphIntoSpoAskSpec> {
    const questionSpec = this.parseQuestionSpec(question.spec);
    const items = questionSpec.items.map((_, index) => {
      let numberOfNotes = 2; // Default number of notes
      switch (question.difficulty) {
        case DifficultyLevel.Easy:
          numberOfNotes = 1;
          break;
        case DifficultyLevel.Medium:
          numberOfNotes = 2;
          break;
        case DifficultyLevel.Hard:
          numberOfNotes = 3;
          break;
        default:
          numberOfNotes = 1;
      }
      return {
        paragraph: questionSpec.items [ index] .paragraph,
        numberOfNotes,
      };
    });
    return {
      items: items,
    };
  }
```

The function F4: ask 408 takes a Question object as input and returns a Promise of TurnParagraphIntoSpoAskSpec. The function F4: ask 408 first parses the question.spec using parseQuestionSpec to get a structured questionSpec. Then, function F4: ask 408 iterates over the items in questionSpec, assigning a numberOfNotes (supporting sentences) based on the question's difficulty level. For example, for ‘Easy’ difficulty level the number of supporting sentences is 1, for ‘Medium’ (which is default) difficulty level the number of supporting sentences is 2, and for ‘Hard’ difficulty level the number of supporting sentences is 3. Each item in the resulting array consists of a paragraph from questionSpec.items and the computed numberOfNotes. Finally, the method returns an object containing the processed items, ensuring the output conforms to TurnParagraphIntoSpoAskSpec.

A function F5: grade 410 executes the one or more pre-define criteria 216, such pre-define criteria is referred as rubric criteria, to evaluate the user response and compiles the final grading output 218. The input received by the function F5: grade 410 is parsed data regarding the paragraph, the required number of details, and the user response. The output generates by the function F5: grade 410 is final for each pre-defined criterion and feedback generated with the grading output 218. The exemplary code for the function F5: grade 410 is shown below:

```
  public async grade(
    questionSpec: Prisma.JsonValue,
    askSpec: Prisma.JsonValue,
    formData: any,
    feedbackStream: FeedbackStream
  ) {
  // Initial parsing of specs and form data
    const q = this.parseQuestionSpec(questionSpec);
    const a = this.parseAskSpec(askSpec);
    const f = this.parseFormData(formData);
  // Initialize the rubric
    const paragraph = a.items [0].paragraph;
    const guess = f.items [0] ;
    const rubric = new Rubric( );
    // Add criteria to the rubric
    rubric.add(
      Rubric.Criteria.TopicSentenceMatchParagraph(guess.ts,
paragraph)
    );
    rubric.add(
      Rubric.Criteria.ConcludingSentenceMatchParagraph(guess.cs,
paragraph)
    );
    guess.notes.forEach(note => {
      rubric.add(Rubric.Criteria.NoteMatchParagraph(note,
paragraph));
      rubric.add(Rubric.Criteria.ExactNoteMatch(note,
paragraph));
    });
    // Check for unique notes
    const allNotesUnique = allUnique(guess.notes);
    // Run the rubric evaluations
    await rubric.run( );
    const resultList = rubric.resultsList( );
    // Generate feedback based on the results
    // ... (Feedback handling code)
  }
```

The function F5: grade 410 evaluates the user response against the one and more pre-defined criteria 216. The function F5: grade 410 first parses the provided questionSpec, askSpec, and formData using dedicated parsing methods to extract structured data. The grading process starts by retrieving the relevant paragraph from askSpec and the student's response (guess) from formData. A Rubric instance is initialized, and grading criteria is added, including checks for topic and concluding sentence alignment, as well as supporting sentences match within the paragraph. Each supporting sentence is further evaluated for uniqueness using allUnique. The rubric is then executed asynchronously, and results are collected by resultList. Finally, the function F5: grade 410 processes the grading output 218 to generate feedback, which is handled via the feedbackStream.

A function F6: allUnique 412 ensures that no two supporting sentences are identical. The input received by the function F6: allUnique 412 is the supporting sentences provided by the user. The output received from the function F6: allUnique 412 is a Boolean indicating whether all supporting sentences are unique. The exemplary code for the function F6: allUnique 412 is shown below.

function allUnique (array: any [ ]) {
return new Set(array).size === array.length;
}

The function F6: allUnique 412 converts the array to a Set (which only stores unique values) and compares its size to the original array length. If size is equal, all elements are unique

A function F7: TopicSentenceMatchParagraph 414 is the pre-defined criteria 216 which uses the prompt from the set of prompts 210 to check if the at least one topic sentence provided by the user matches or correctly identifies the paragraph topic sentence. Based on the evaluation the output received from the function F7: TopicSentenceMatchParagraph 414 is ‘Yes’ or ‘No.’ The exemplary code for the function F7:

```
  export function TopicSentenceMatchParagraph(
    topicSentence: string,
    paragraph: string
  ): Criteria {
    return {
      label: ‘Is the topic sentence correct?’,
      evaluate: async ( ) => {
        const text = ‘You are an English teacher grading a
student exercise. The student was given this paragraph:
  “${paragraph}”
  The student was asked to identify the topic sentence. They
wrote:
  “${topicSentence}”
  Did the student correctly identify the topic sentence? Answer
with a Yes or No only.’;
        const response = await prompts.yesNo({ text });
        const correct = response === true;
        return {
          correct,
          response: yesNo(correct),
        };
      },
    };
  }
```

Within braces { . . . } in a prompt are named imports that are placeholders for the retrieval and insertion of data, variables, or functions. The function F7: TopicSentenceMatchParagraph 414 evaluates whether the user identified topic sentence is correct. The function F7: TopicSentenceMatchParagraph 414 returns a Criteria object with a label and an asynchronous evaluate method. The prompt generator 212 constructs the prompt instructing the AI engine 214 to assess whether the provided topicSentence correctly identifies the main idea of the given paragraph. The AI engine 214 responds with a ‘Yes’ or ‘No,’ which is then interpreted as a Boolean value (correct). The function F7: TopicSentenceMatchParagraph 414 returns an evaluation result containing the correctness flag and a formatted response (yesNo (correct)). Therefore, ensuring an automated, consistent assessment of topic sentence identification.

A function F8: ConcludingSentenceMatchParagraph 416 is the pre-defined criteria 216 which uses the prompt from the set of prompts 210 to verify whether the concluding sentence provided by the user is the complete concluding sentence of the paragraph. The exemplary code for the function F8: ConcludingSentenceMatchParagraph 416 is shown below.

```
  export function ConcludingSentenceMatchParagraph(
    concludingSentence: string,
paragraph: string
  ): Criteria {
    return {
      label: ‘Is the concluding sentence correct?’,
      evaluate: async ( ) => {
        const text = ‘You are an English teacher grading a
student exercise. The student was given this paragraph:
  “${paragraph}”
  The student was asked to identify which sentence from the
paragraph is the concluding sentence. The student answered with:
  “${concludingSentence}”
  Is the student's answer the *full*, not partial, complete
concluding sentence? Do not consider partial answers correct. The
student's answer should match the paragraph's concluding sentence in
full. Answer with a Yes or No only.’;
        const response = await prompts.yesNo({ text });
        const correct = response === true;
        return {
          correct,
          response: yesNo(correct),
        };
      },
    };
  }
```

The function F8: ConcludingSentenceMatchParagraph 416 evaluate whether the user identified concluding sentence matches the actual concluding sentence of a given paragraph. It returns a Criteria object with a label and an asynchronous evaluate method. The prompt generator 212 constructs a prompt to instruct the AI engine 214 to determine if the provided concludingSentence is a complete and exact match to the concluding sentence in paragraph, explicitly rejecting partial answers. The AI engine 214 responds with ‘Yes’ or ‘No,’ which is converted into a Boolean (correct). The function F8:
ConcludingSentenceMatchParagraph 416 then returns an evaluation result containing this correctness flag and a formatted response (yesNo (correct).

A function F9: NoteMatchParagraph 418 is the pre-defined criteria 216 which checks whether each supporting sentence is relevant to the presented paragraph content. The function F9: NoteMatchParagraph 418 ensures the supporting sentence is semantically tied to the paragraph information. The exemplary code for function F9: NoteMatchParagraph 418 is shown below:

```
  export function NoteMatchParagraph(note: string, paragraph:
string): Criteria {
    return {
      label: ‘Does the detail “${note}” fit the paragraph?’,
      evaluate: async ( ) => {
        const text = ‘You are an English teacher grading a
student exercise. The student was given this paragraph:
  “${paragraph}”
  The student was asked to identify supporting details in order
to generate a Single Paragraph Outline. Here are the supporting
details the student wrote:
  - ${note}
  Do the student's supporting detail fit? Respond with Yes or No
only.’;
        const response = await prompts.yesNo({ text });
        const correct = response === true;
        return {
          correct,
          response: yesNo(correct),
        };
      },
    };
  }
```

The function F9: NoteMatchParagraph 418 evaluates whether the user identified supporting sentence (note) is relevant to a given paragraph. The function F9: NoteMatchParagraph 418 returns a Criteria object with a label and an asynchronous evaluate method. The prompt generator 212 constructs a prompt instructing the AI engine 214 to assess whether the provided note accurately fits as a supporting sentence within the paragraph. The AI engine 214 responds with ‘Yes’ or ‘No,’ which is converted into a Boolean (correct). The function F9: NoteMatchParagraph 418 then returns an evaluation result containing this correctness flag and a formatted response (yesNo (correct)).

A function F10: ExactNoteMatch 420 is the pre-defined criteria 216 which detects if the supporting sentence is merely copy-pasted from the paragraph rather than paraphrased. Typically, the AI engine 214 is configured to check for a threshold of “at least three words changed.” The exemplary code for the F10: ExactNoteMatch 420 is shown below.

```
  export function ExactNoteMatch(note: string, paragraph:
string): Criteria {
    return {
  label: ‘Is the detail “${note}” an exact copy from the
paragraph? We want students to paraphrase the detail sentence, not
copy-paste from it.’,
  evaluate: async ( ) => {
      const text = ‘You are an English teacher grading a
student exercise. The student was given this paragraph:
  “${paragraph}”
  The student was asked to identify supporting details in order
to generate a Single Paragraph Outline. Here are the supporting
details the student wrote:
  - ${note}
  We don't want the student to exactly copy and paste the
sentence. So notes should be relevant and similar to the detail
sentences, but not verbatim copies. The detail sentence should have
at least three words changed.
  Does the student's supporting detail seem like a copy and
paste, more or less? Respond with Yes or No only.’;
  const response = await prompts.yesNo({ text });
      const correct = response === false;
        return {
          correct,
          response: yesNo(!correct),
        };
      },
    };
  }
```

The function F10: ExactNoteMatch 420 checks whether the supporting sentences (note) provided by the user is an exact copy from the paragraph, encouraging paraphrasing instead of direct copying. It returns a Criteria object with a label and an asynchronous evaluate method. The prompt generator 212 constructs a prompt instructing the AI engine 214 to determine if the note closely resembles a sentence from the paragraph without sufficient modification. The AI engine 214 responds with ‘Yes’ or ‘No,’ and the result is interpreted so that an exact match is considered incorrect (correct=false). The function F10: ExactNoteMatch 420 returns an evaluation result, ensuring user paraphrase the presented paragraph rather than copy-paste supporting sentences.

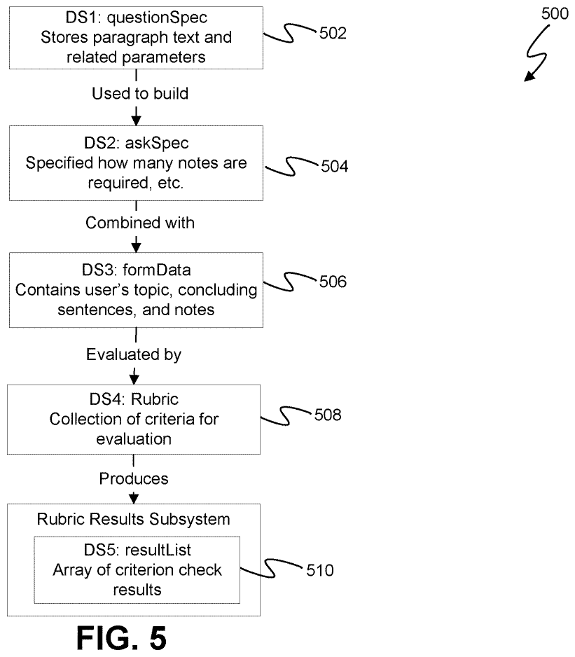

FIG. 5 depicts an exemplary diagram showing data structures 500 used to structure and organize the data of the AI-guided turn-paragraph into single paragraph educational outline activity grading system 200 of FIG. 2.

A data structure DS1: questionSpec 502 holds the main paragraph(s) and any parameters used to define the question, such as difficulty level used by the function F1: parseQuestionSpec 402. The paragraph is fetched from a database or external source. Below is an exemplary code showing the parameters used to define the question:

```
  {
    “items”: [
      {
        “paragraph”: “Recycling paper reduces waste in landfills.
It also conserves natural resources. Therefore, everyone should
recycle paper whenever possible. ″
      }
      ]
  }
  Difficulty: Medium (2 supporting notes).
```

The given JSON structure contains an array named items, which includes an object with a paragraph about the benefits of recycling paper. The difficulty level is marked as ‘Medium,’ requiring two supporting sentences.

A data structure DS2: askSpec 504 declares how many supporting sentences the user should provide in the response, which is identified in the function F1: parseQuestionSpec 402 based on difficulty level. The data structure DS2: askSpec 504 uses the function F2: parseAskSpec 404. Below is an exemplary code showing the minimum number of supporting sentences the user should provide:

```
  {
    “items”: [
      {
        “paragraph”: “Recycling paper reduces waste in landfills.
It also conserves natural resources. Therefore, everyone should
recycle paper whenever possible.”,
        “numberOfNotes”: 2
      }
    ]
  }
```

The function of this JSON structure is to store and organize textual data along with metadata. It contains array items, where each object includes a paragraph that presents information about recycling paper, highlighting its benefits in reducing landfill waste and conserving resources. Additionally, the numberOfNotes field specifies that two supporting sentences are required, indicating further explanations or evidence should be provided to justify the paragraph.

A data structure DS3: formData 506 stores the user responses, including the at least one topic sentence, concluding sentence, and one or more supporting sentences used in the function F3: parseFormData 406. Below is an exemplary code showing the user response:

```
  {
    “items”: [
      {
        “ts”: “Recycling paper reduces waste in landfills.”,
        “cs”: “Therefore, everyone should recycle paper whenever
possible.”,
        “notes”: [
          “It helps protect forests and cut down on trash.”,
          “Reusing paper is good for the environment”
        ]
      }
    ]
  }
```

The JSON structure organizes information into an items array, where each object contains different fields related to a statement about recycling paper. The ‘ts’ (topic sentence) field presents the main idea: recycling paper reduces landfill waste. The ‘cs’ (concluding sentence) field provides a message, encouraging people to recycle paper whenever possible. The ‘notes’ field contains an array of supporting sentences that justify the topic sentence, explaining how recycling protects forests and benefits the environment.

A data structure DS4: Rubric 508 holds the structure for one or more pre-defined criteria 216 to check the correctness of the at least one topic sentence and concluding sentence, relevance and paraphrasing of the one or more supporting sentence used in function F4: ask 408.

A data structure DS5: resultList 510 collects the pass or fail outcomes of each criterion from the one or more pre-defined criteria 216 and provides an array or object with yes or no outcomes, associated feedback or messages. The outcome is returned on the user interface 208. Below is an exemplary code showing the parameters used to collect outcomes from the one or more pre-defined criteria 216:

```
  {
    “gradingResults”: {
      “topicSentence”: “Correct”,
      “concludingSentence”: “Correct”,
      “notes”: [
        {
          “note”: “It helps protect forests and cut down on
trash.”,
          “result”: “Correct”
        },
        {
          “note”: “Reusing paper is good for the environment”,
          “result”: “Correct”
        }
      ]
    },
    “feedback”: “Great job! Your topic and concluding sentences
are correct, and your supporting notes are both relevant and
paraphrased.”
  }
```

This JSON structure represents grading results and feedback for a written response. The ‘gradingResults’ object evaluates different components of the response, marking the ‘topicSentence’ and ‘concludingSentence’ as ‘Correct.’ The ‘notes’ array assesses supporting sentences, with each ‘note’ receiving a ‘result’ of ‘Correct,’ indicating they are relevant and well-paraphrased. The ‘feedback’ field provides an overall assessment, praising the accuracy of the topic and concluding sentences, as well as the quality of the supporting sentences.

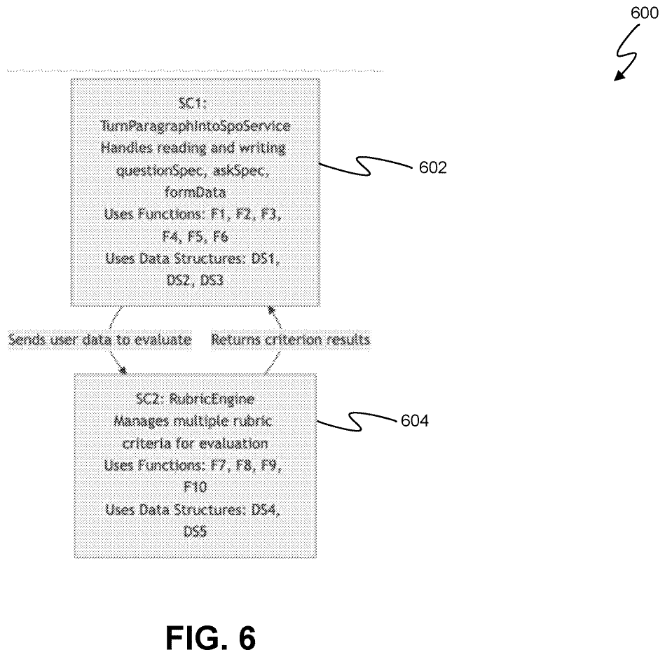

FIG. 6 depicts an exemplary ecosystem diagram 600 including system components used by the AI-guided turn-paragraph into single paragraph educational outline activity grading system of FIG. 1.

A system component SC1: TurnParagraphIntoSpoService 602 orchestrates the entire grading process using the function. The system component sc1:
TurnParagraphIntoSpoService 602 utilizes function F1: parseQuestionSpec 402, F2: parseAskSpec 404, F3: parseFormData 406, F4: ask 408, F5: grade 410, F6: allUnique 412 to prepare the grading output 218. Moreover, the system component Sc1: TurnParagraphIntoSpoService 602 utilizes the data structures DS1: questionSpec 502, DS2: askSpec 504, and DS3: formData 506 to store relevant data. The system component SC1: TurnParagraphIntoSpoService 602 communicates with a system component sc2: RubricEngine to evaluate the user response based on the one or more pre-defined criteria 216.

A system component sc2: RubricEngine 604 provides a structured approach to evaluate the user response. The evaluation process include evaluation the at least one topic sentence, one or more supporting sentences and concluding sentence. The system component SC2: RubricEngine 604 calls the functions F7: TopicSentenceMatchParagraph 414, F8: ConcludingSentenceMatchParagraph 416, F9: NoteMatchParagraph 418, and F10: ExactNoteMatch 420 to perform evaluation. The system component SC2: RubricEngine 604 utilizes the data structures DS4: Rubric 508, DS5: resultList 510 to utilize the utilize one or more pre-defined criteria 216 and store evaluation result. The system component sc2: RubricEngine 604 receives parsed data from the system component sc1: TurnParagraphIntoSpoService 602 and returns the final evaluations. The final evaluation includes evaluated user response.

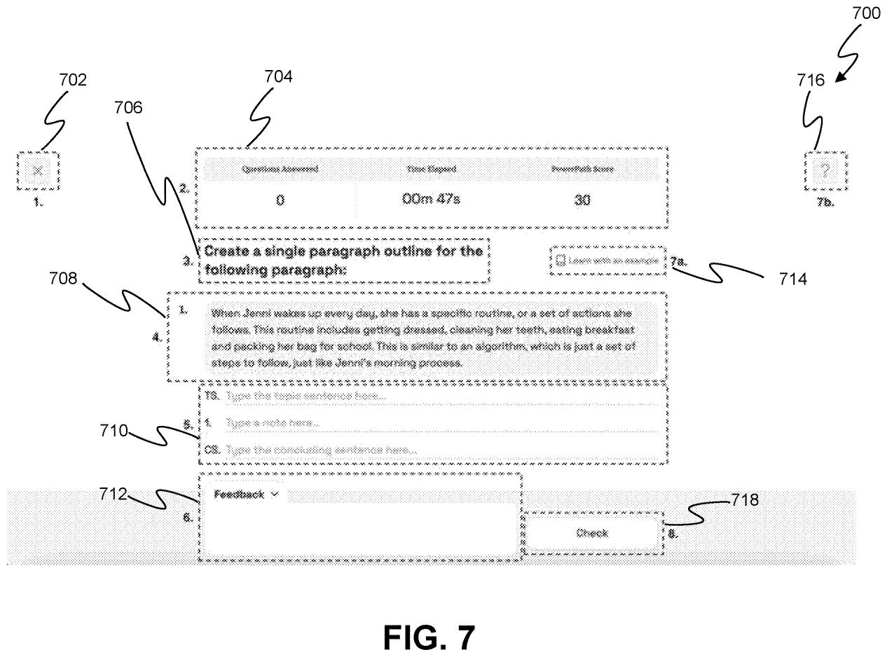

FIG. 7 is an exemplary user interface 700 depicting various elements of the online learning platform 206. As shown the user may click on “X” button 702 to close the activity anytime. A session info display 704 displays a readout of current session information such as a number of questions answered by the user, time taken to complete the exercise, score to show the score of the user based on the user response. An instructions bar 706 provides details about the current exercise. The question is provided to the user, and the user engages with the question based on the instruction 706 provided.

A generated question 708 displayed to the user to test the knowledge on turn-paragraph into SPO′ activity. The user is supposed to provide the response of the generated question 708 based on the instruction provided in the instructions bar 706. A response field 710 is provided to the user for inputting the user. A feedback bar 712 displays generated feedback based on the user response. A learn with an example tab 714 displays an instructional popup to explain how to perform the exercise when the user clicks on the tab 714. A help tab 716, opens an instructional popup to help the user during the activity. A check button 718 allows the user to click and submit the user response for activity grading.

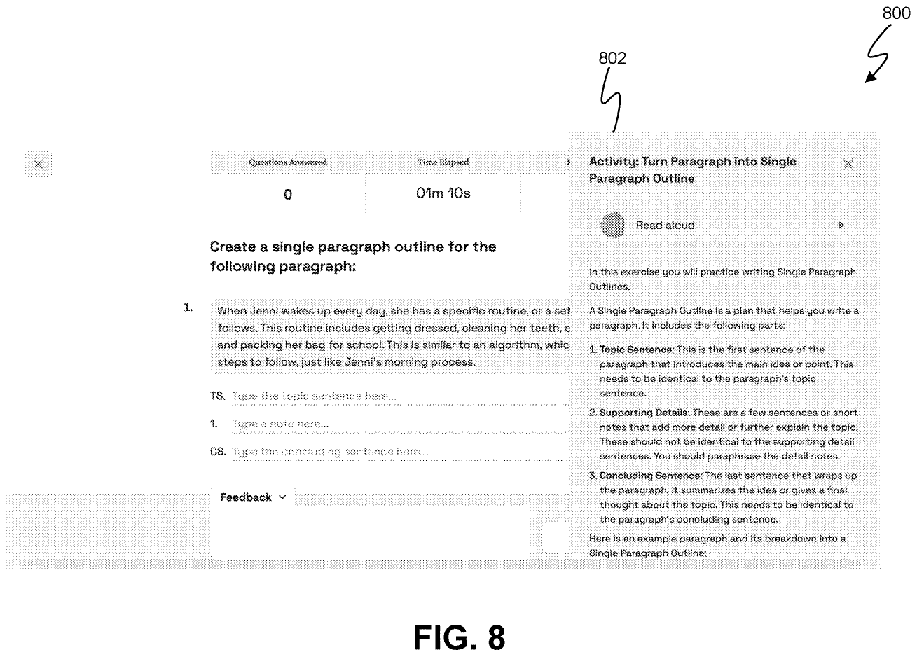

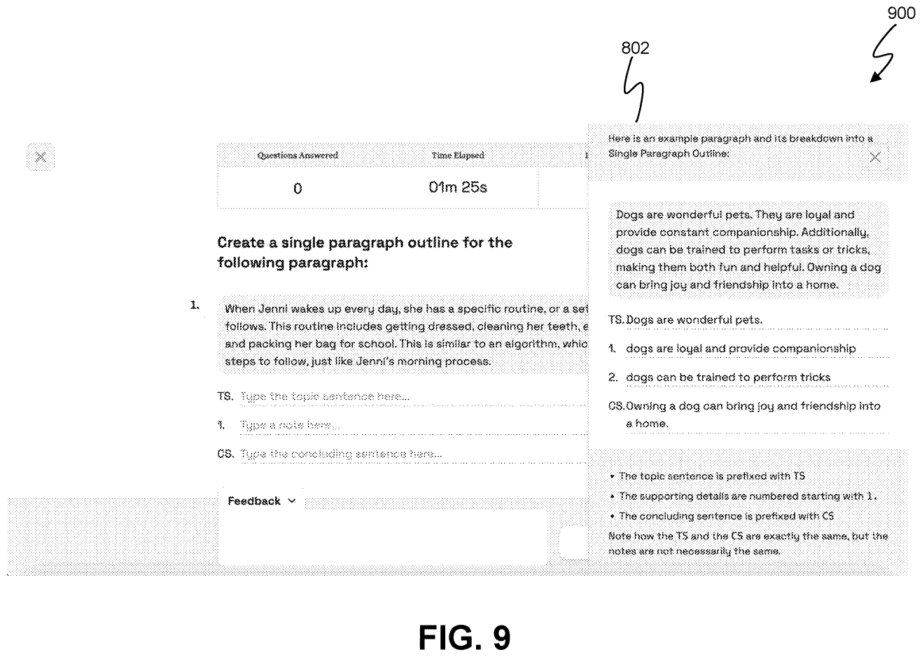

FIGS. 8-9 are exemplary user interfaces 800 and 900 depicting example for user to learn the turn paragraph into single paragraph educational outline activity.

FIGS. 8 and 9 depict user interfaces 800 and 900 showing a dropdown window 802 which is displayed when the user clicks on the learn with an example tab 714. The learn with an example tab 714 allow the user to explain the task for the turn paragraph into SPO activity. The dropdown window 802 of the learn with an example tab 714 provides note context and answer requirements. As shown in FIG. 9, an exemplary paragraph is provided to the user and the corresponding at least one topic sentence, one or more supporting sentences, and concluding sentence is provided to the user.

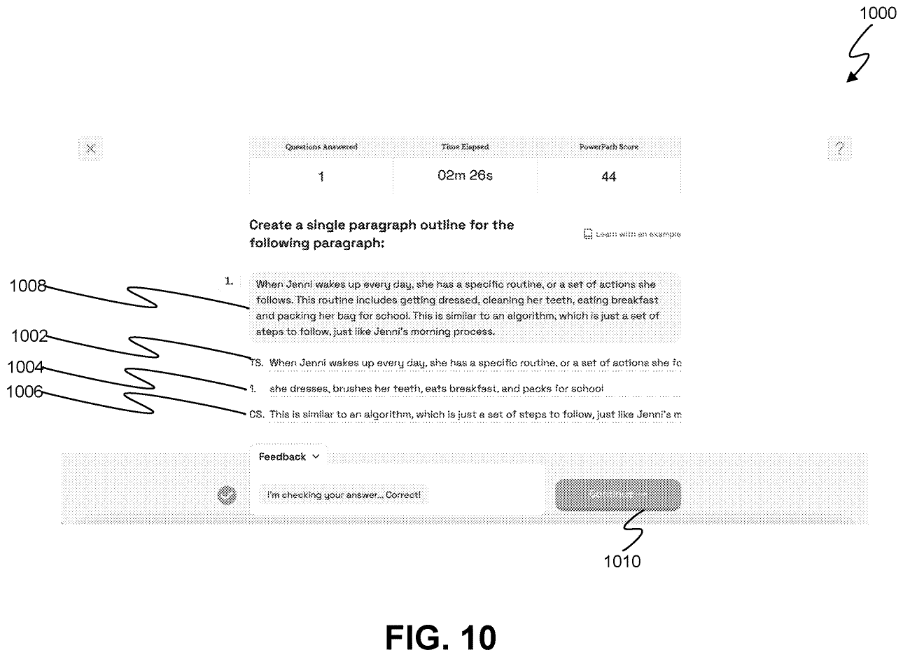

FIGS. 10-13 are exemplary user interfaces 1000, 1100, 1200 and 1300 depicting the correction process for updating a topic sentence based on the feedback.

Referring to FIG. 10, the user interface 1000 shows an example of correct answer including topic sentence 1002, supporting sentences 1004, and concluding sentence 1006 provided by the user to a question 1008. If the answer given by the user is correct, the check button 718 changes into a continue button 1010.

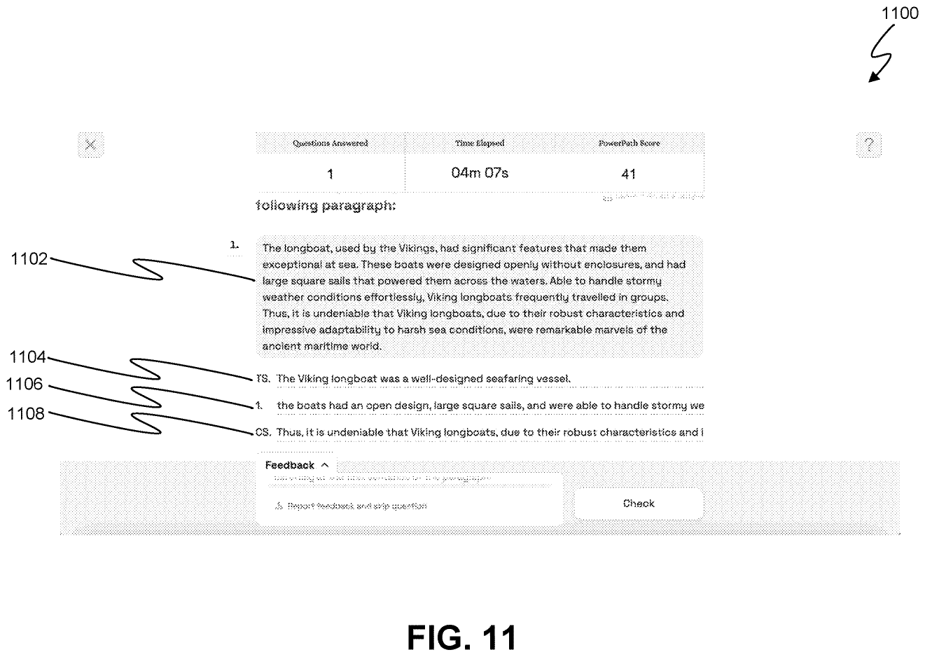

Referring to FIG. 11, the user interface 1100 shows another exemplary question 1102. The user provides a topic sentence 1104, supporting sentences 1106, and concluding sentence 1108. The user provides an incorrect answer to the provided question 1102. Moreover, the reason for the incorrect answer is that the topic sentence 1104 does not match question 1102.

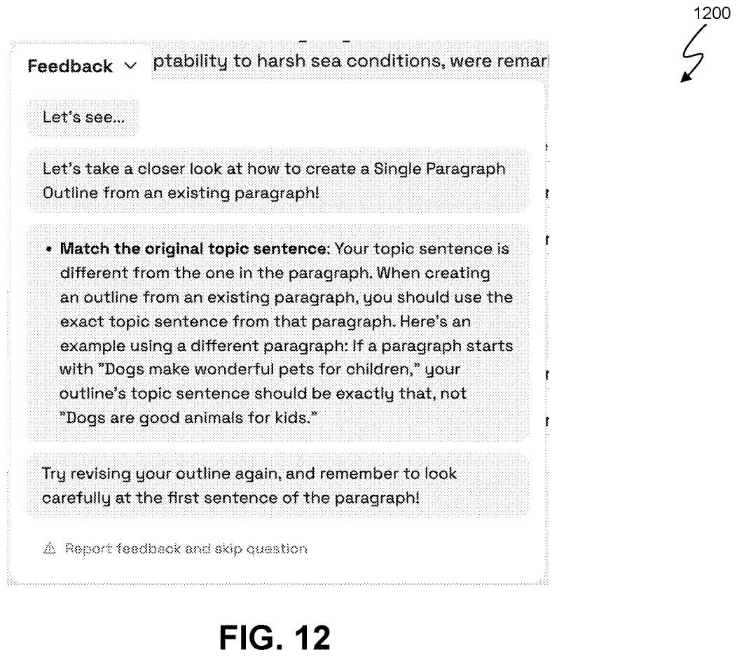

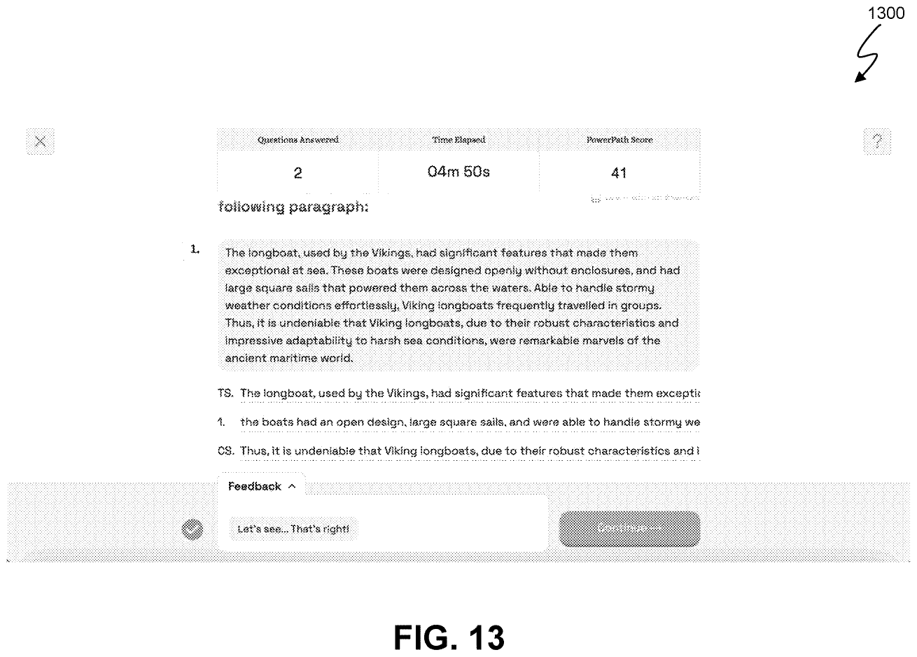

Referring to FIG. 12, the user interface 1200 showing explanation for the incorrect answer to the question 1102 from FIG. 11. The feedback bar 712 displays generated feedback based on the user response. Referring to FIG. 13, the user interface 1300 shows updated topic sentence based on the feedback provided in FIG. 12.

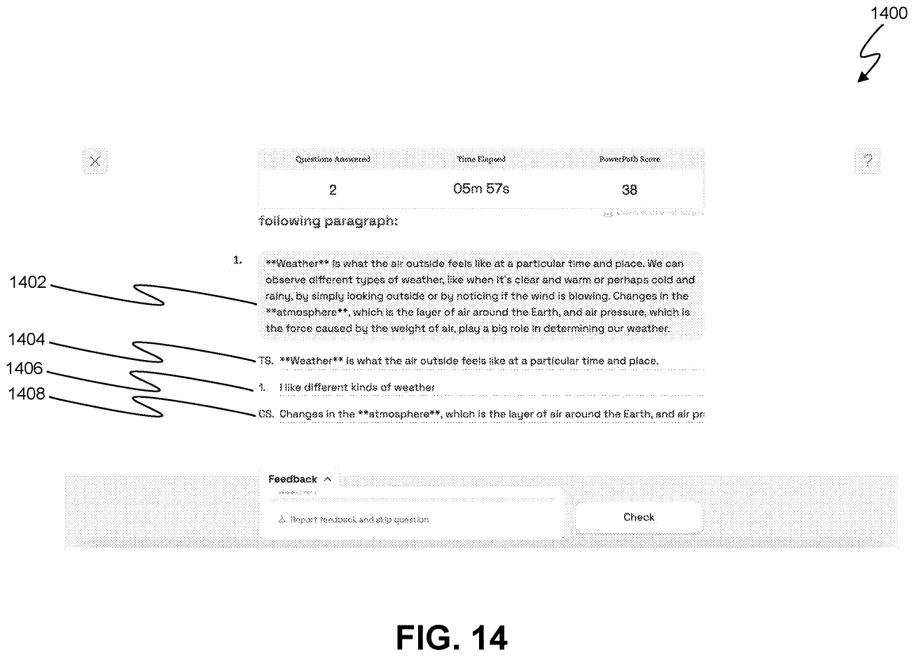

FIGS. 14-16 depict exemplary user interfaces 1400, 1500, and 1600 showing the correction process for updating a supporting sentence based on the feedback.

Referring to FIG. 14, the user interface 1400 shows another exemplary question 1402. The user provides a topic sentence 1404, supporting sentences 1406, and concluding sentence 1408 based on the question 1402. The user provides an incorrect answer to the provided question 1402. The reason for the incorrect answer is that the supporting sentences 1406 do not correspond with supporting sentences from the question 1402.

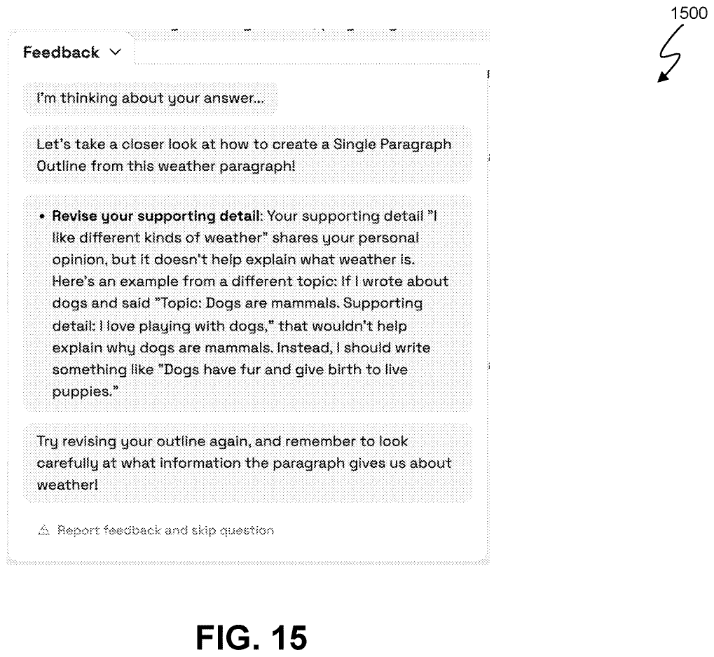

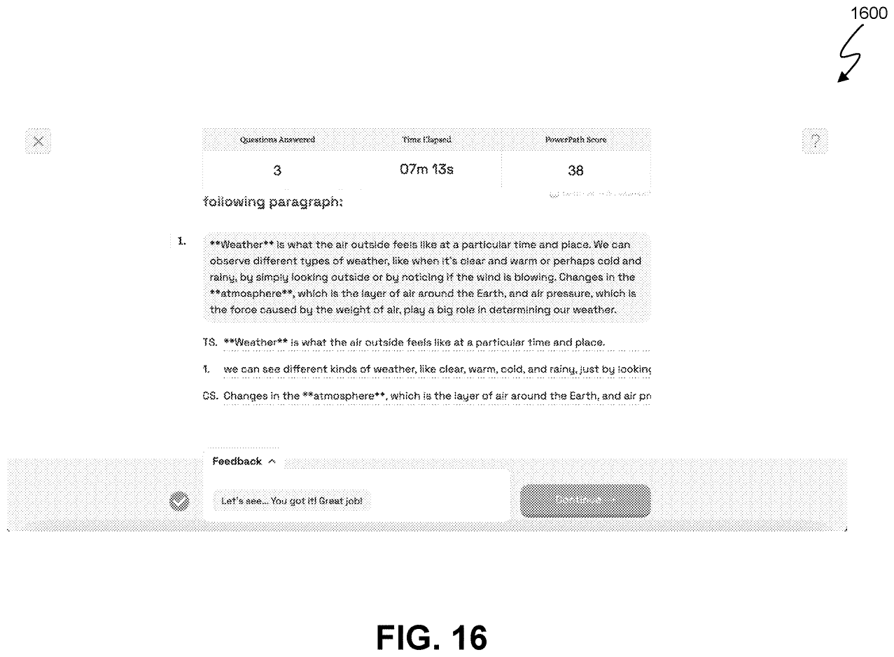

Referring to FIG. 15, the user interface 1500 shows feedback for the incorrect answer to the question 1402. A feedback bar 712 displays generated feedback based on the user response. Referring to FIG. 16, the user interface 1600 shows the user update to the supporting sentences 1406 based on the feedback provided in the FIG. 15.

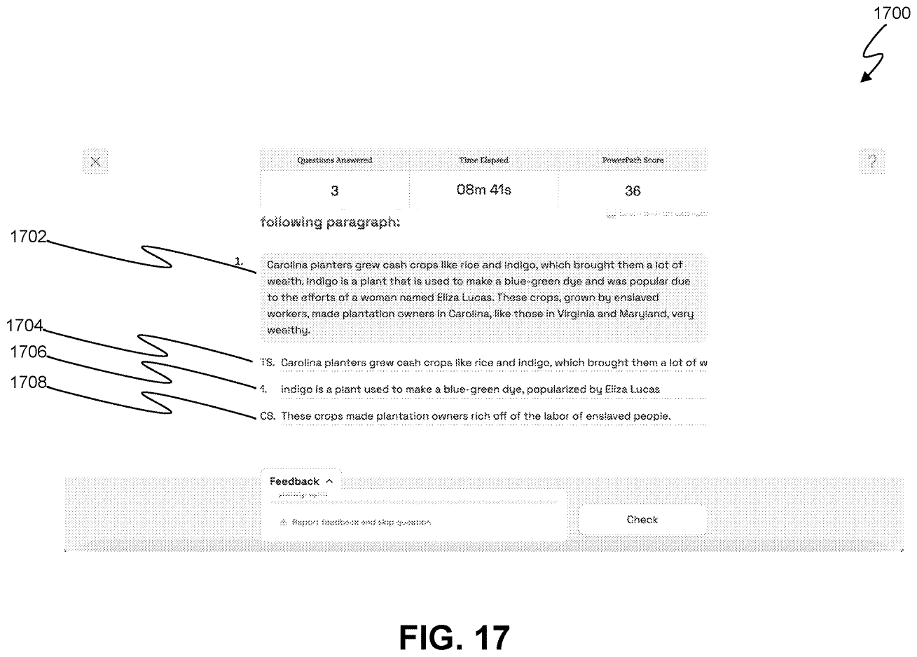

FIGS. 17-19 are exemplary user interfaces 1700, 1800, and 1900 depicting the correction process for updating a concluding sentence based on the feedback.

Referring to FIG. 17 depicts the user interface 1700 showing another exemplary question 1702. The user provides a topic sentence 1704, supporting sentences 1706, and concluding sentence 1708 based on the question 1702. The user provides an incorrect answer to the provided question 1702. The reason for the incorrect answer is that the concluding sentence 1708 does not match concluding sentence given in the question 1702.

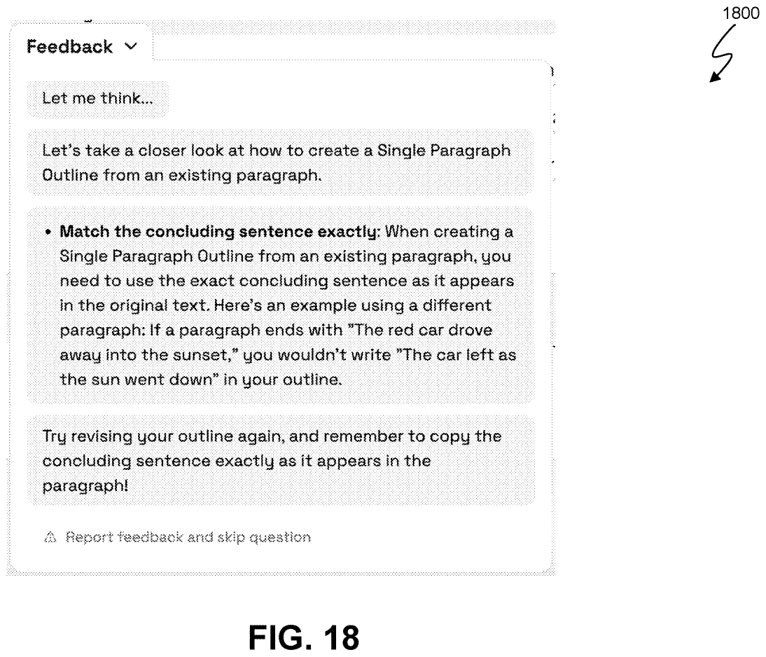

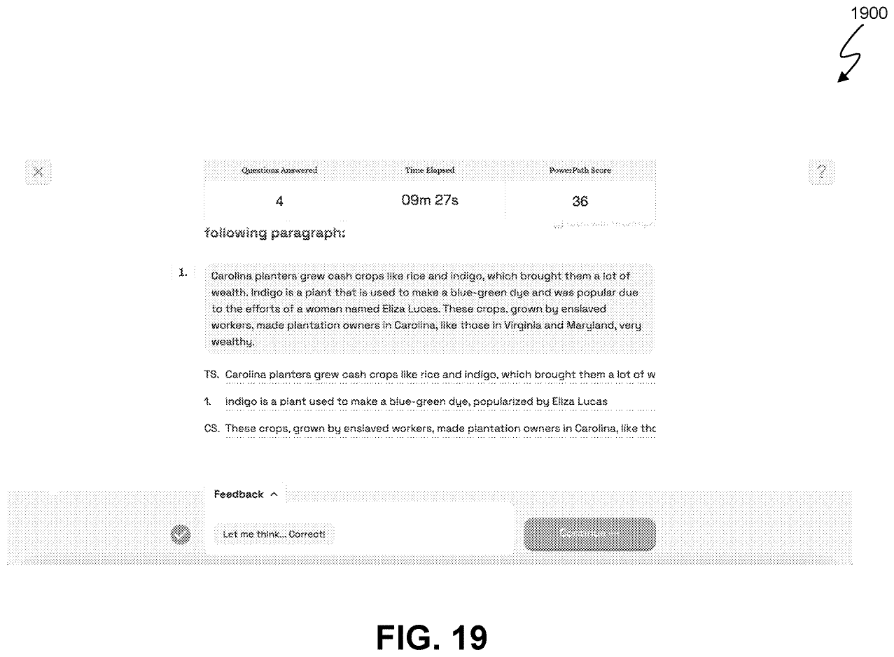

Referring to FIG. 18, the user interface 1800 shows feedback for the incorrect answer to the question 1702 from FIG. 17. A feedback bar 712 displays generated feedback based on the user response. Referring to FIG. 19, the user interface 1900 shows that the user has updated the concluding sentence 1708 based on the feedback provided in FIG. 18.

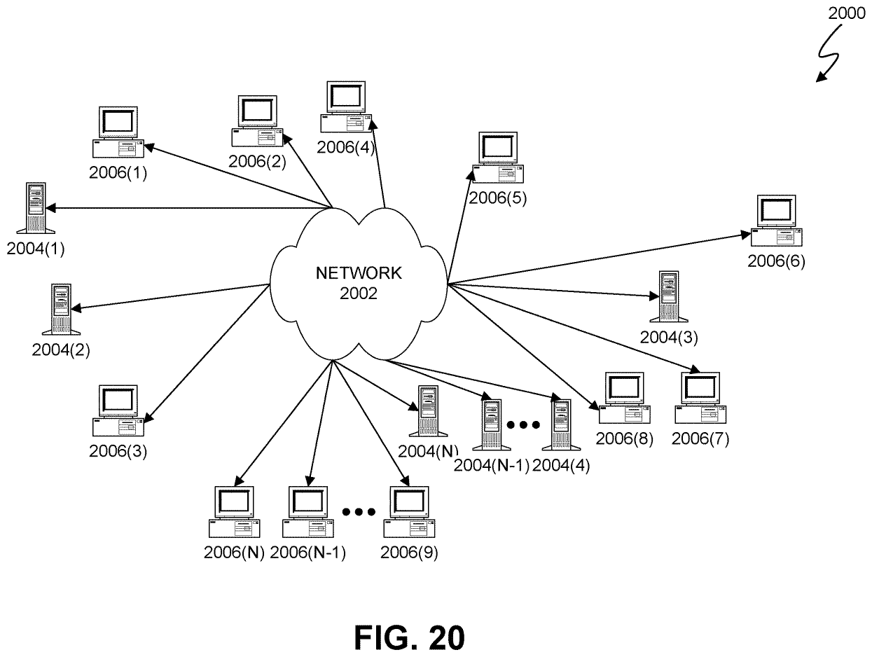

FIG. 20 is a block diagram illustrating a network environment in which an AI-guided turn-paragraph into single paragraph educational outline activity grading system 200 and AI-guided turn-paragraph into single paragraph educational outline activity grading process 300 may be practiced. Network 2002 (e.g. a private wide area network (WAN) or the Internet) includes a number of networked server computer systems 2004(1)-(N) that are accessible by client computer systems 2006(1)-(N), where N is the number of server computer systems connected to the network. Communication between client computer systems 2006(1)-(N) and server computer systems 2004(1)-(N) typically occurs over a network, such as a public switched telephone network over asynchronous digital subscriber line (ADSL) telephone lines or high-bandwidth trunks, for example communications channels providing T1 or OC3 service. Client computer systems 2006(1)-(N) typically access server computer systems 2004(1)-(N) through a service provider, such as an internet service provider (“ISP”) by executing application specific software, commonly referred to as a browser, on one of client computer systems 2006(1)-(N).

Client computer systems 2006(1)-(N) and/or server computer systems 2004(1)-(N) are specialized computer programmed to improve conventional computer systems to implement and utilize the AI-guided turn-paragraph into single paragraph educational outline activity grading system 200 and AI-guided turn-paragraph into single paragraph educational outline activity grading process 300. The type of computer system that can be specially programmed to implement and utilize the AI-guided turn-paragraph into single paragraph educational outline activity grading system 200 and AI-guided turn-paragraph into single paragraph educational outline activity grading process 300 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the AI-guided turn-paragraph into single paragraph educational outline activity grading system 200 and AI-guided turn-paragraph into single paragraph educational outline activity grading process 300 can be implemented using code stored in a tangible, non-transient computer readable medium and executed by one or more processors. In at least one embodiment, the AI-guided turn-paragraph into single paragraph educational outline activity grading system 200 and AI-guided turn-paragraph into single paragraph educational outline activity grading process 300 can be implemented completely in hardware using, for example, logic circuits and other circuits including field programmable gate arrays.

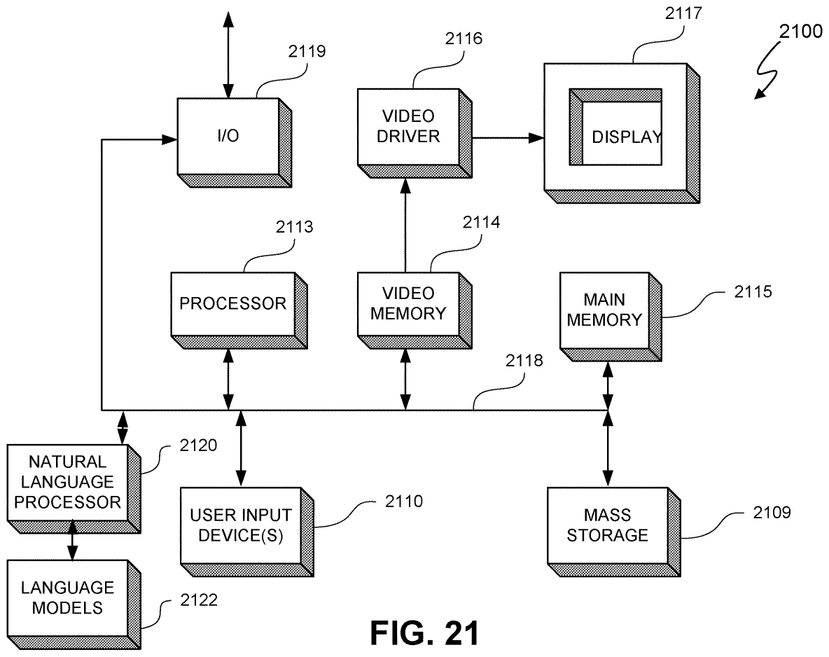

Embodiments of the AI-guided turn-paragraph into single paragraph educational outline activity grading system 200 and AI-guided turn-paragraph into single paragraph educational outline activity grading process 300 can be implemented on a computer system such as a special-purpose, special-programmed computer 2100 illustrated in FIG. 21. Input user device(s) 2110, such as a keyboard and/or mouse, are coupled to a bi-directional system bus 2118. The input user device(s) 2110 are for introducing user input to the computer system and communicating that user input to processor 2113. The computer system of FIG. 21 generally also includes a non-transitory video memory 2114, non-transitory main memory 2115, and non-transitory mass storage 2109, all coupled to bi-directional system bus 2118 along with input user device(s) 2110 and processor 2113. The mass storage 2109 may include both fixed and removable media, such as a hard drive, one or more CDs or DVDs, solid state memory including flash memory, and other available mass storage technology. Bus 2118 may contain, for example, 32 of 64 address lines for addressing video memory 2114 or main memory 2115. The system bus 2118 also includes, for example, an n-bit data bus for transferring DATA between and among the components, such as CPU 2109, main memory 2115, video memory 2114 and mass storage 2109, where “n” is, for example, 32 or 64. Alternatively, multiplex data/address lines may be used instead of separate data and address lines.

I/O device(s) 2119 may provide connections to peripheral devices, such as a printer, and may also provide a direct connection to a remote server computer systems via a telephone link or to the Internet via an ISP. I/O device(s) 2119 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 2109, into main memory 2115 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 2113, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 2115 is comprised of dynamic random access memory (DRAM). Video memory 2114 is a dual-ported video random access memory. One port of the video memory 2114 is coupled to video amplifier 2116. The video amplifier 2116 is used to drive the display 2117. Video amplifier 2116 is well known in the art and may be implemented by any suitable means. This circuitry converts pixel DATA stored in video memory 2114 to a raster signal suitable for use by display 2117. Display 2117 is a type of monitor suitable for displaying graphic images.

The computer system described above is for purposes of example only. The AI-guided turn-paragraph into single paragraph educational outline activity grading system 200 and AI-guided turn-paragraph into single paragraph educational outline activity grading process 300 may be implemented in any type of computer system or programming or processing environment. It is contemplated that the AI-guided turn-paragraph into single paragraph educational outline activity grading system 200 and AI-guided turn-paragraph into single paragraph educational outline activity grading process 300 might be run on a stand-alone computer system, such as the one described above. The AI-guided turn-paragraph into single paragraph educational outline activity grading system 200 and AI-guided turn-paragraph into single paragraph educational outline activity grading process 300 might also be run from a server computer systems system that can be accessed by a plurality of client computer systems interconnected over an intranet network. Finally, the AI-guided turn-paragraph into single paragraph educational outline activity grading system 200 and AI-guided turn-paragraph into single paragraph educational outline activity grading process 300 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for guiding an Artificial Intelligence (AI) engine for grading a user response submitted for turn-paragraph into single paragraph educational outline activity, the method comprising:
executing code using one or more processors of a computer system to cause the computer system to perform operations comprising:
receiving a grading input including a presented question and the user response to the question, wherein the presented question includes a paragraph along with a plurality of placeholders where the user adds the response, wherein the user response includes at least one topic sentence, one or more supporting sentences, and a concluding sentence;
generating a set of prompts, via a prompt generator, for evaluating the user response;
transferring the set of prompts to the AI engine to evaluate the user response based on one or more pre-defined criteria including:
checking if the at least one topic sentence provided by the user matches the actual topic sentence of the paragraph;
verifying if the concluding sentence provided by the user matches the concluding sentence of the paragraph;
checking if each supporting sentence provided by the user is relevant to the paragraph; and
determining if the supporting sentence is a paraphrase rather than a direct copy from the paragraph;
generating a grading output for the user response, wherein the grading output incudes a Boolean response such that the grading output is ‘pass’ if the user response passes against each of the pre-defined criteria and the grading output is ‘fail’ if the user response fails on at least one of the pre-defined criteria; and
presenting the grading output along with a feedback, wherein the feedback includes detailed explanation about the grading output.

2. The method of claim 1 wherein adding the user response includes allowing the user to fill the one or more placeholders to restate user's understanding about the provided paragraph, wherein the user picks one or more sentences from the paragraph to add the topic sentence and the concluding sentence in the one or more placeholders, and the user paraphrases a portion of the paragraph to provide one or more concluding sentences in respective one or more placeholders.

3. The method of claim 1, wherein the number of supporting sentences required depends on the difficulty level and/or the grade level of the user such that for an easy difficulty level the number of supporting sentences required is 1, for medium difficulty level the number of supporting sentences required is 2, and for hard difficulty level the number of supporting sentences required is 3.

4. The method of claim 1 further comprises presenting a hint to the user if the grading output is ‘fail’, wherein the hint guides the user towards re-writing at least one of the topic sentence, supporting sentences, and concluding sentence, without disclosing the exact answer.

5. The method of claim 1 further comprises:
performing semantic analysis on the user response for accurate evaluation.

6. The method of claim 1 further comprises:
detecting the direct copy of the user response from the paragraph to enforce uniqueness and originality of the user response.

7. The method of claim 1 wherein the turn-paragraph into single paragraph educational outline activity is aligned to the standards of Common Core English Language Arts.

8. The method of claim 1 wherein storing the user response in the database comprises:
converting the user response into a JSON-formatted structure.

9. The method of claim 1 further comprises utilizing a Zod library for validating the user response.

10. A system for guiding an Artificial Intelligence (AI) engine for grading a user response submitted for turn-paragraph into single paragraph educational outline activity, the method comprising:
one or more processors of a computer system; and
a memory, coupled to the one or more processors, that stores code and execution of the code by the one or more processors causes the computer system to perform operations comprising:
receiving a grading input including a presented question and the user response to the question, via a turn-paragraph into single paragraph educational outline activity grader, wherein the presented question includes a paragraph along with a plurality of placeholders where the user adds the response, wherein the user response includes at least one topic sentence, one or more supporting sentences, and a concluding sentence;
generating a set of prompts, via a prompt generator, for evaluating the user response;
transferring the set of prompts to the AI engine to evaluate the user response based on one or more pre-defined criteria including:
checking if the at least one topic sentence provided by the user matches the actual topic sentence of the paragraph;
verifying if the concluding sentence provided by the user matches the concluding sentence of the paragraph;
checking if each supporting sentence provided by the user is relevant to the paragraph; and
determining if the supporting sentence is a paraphrase rather than a direct copy from the paragraph;
generating a grading output for the user response via grading module, wherein the grading output incudes a Boolean response such that the grading output is ‘pass’ if the user response passes against each of the pre-defined criteria and the grading output is ‘fail’ if the user response fails on at least one of the pre-defined criteria; and
presenting the grading output along with a feedback, via a user interface of an online learning platform, wherein the feedback includes detailed explanation about the grading output.

11. The system of claim 9 wherein adding the user response includes allowing the user to fill the one or more placeholders to restate user's understanding about the provided paragraph, wherein the user picks one or more sentences from the paragraph to add the topic sentence and the concluding sentence in the one or more placeholders, and the user paraphrases a portion of the paragraph to provide one or more concluding sentences in respective one or more placeholders.

12. The system of claim 9 wherein the number of supporting sentences required depends on the difficulty level and/or the grade level of the user such that for an easy difficulty level the number of supporting sentences required is 1, for medium difficulty level the number of supporting sentences required is 2, and for hard difficulty level the number of supporting sentences required is 3

13. The system of claim 9 wherein execution of the code by the one or more processors causes the computer system to perform further operations comprising:
presenting a hint to the user, via the user interface, if the grading output is ‘fail’, wherein the hint guides the user towards re-writing at least one of the topic sentence, supporting sentences, and concluding sentence, without disclosing the exact answer.

14. The system of claim 9 f wherein execution of the code by the one or more processors causes the computer system to perform further operations comprising:
performing semantic analysis on the user response for accurate evaluation.

15. The system of claim 9 wherein the turn-paragraph into single paragraph educational outline activity is aligned to the standards of Common Core English Language Arts.

16. The system of claim 9 wherein storing the user response in the database comprises:
converting the user response into a JSON-formatted structure.

17. The system of claim 9 wherein execution of the code by the one or more processors causes the computer system to perform further operations comprising:
utilizing a Zod library for validating the user response.

18. The system of claim 9 wherein execution of the code by the one or more processors causes the computer system to perform further operations comprising:
detecting the direct copy of the user response from the paragraph to enforce uniqueness and originality of the user response.
